(19) United States
(12) Patent Application Publication
(10) Pub. No.: US 2013/0341573 A1
(43) Pub. Date: Dec. 26, 2013

(54) PHOTOREFRACTIVE COMPOSITION COMPRISING ELECTROLYTES IN A PHOTOREFRACTIVE LAYER AND METHOD OF MAKING THEREOF

(71) Applicants: Weiping Lin, Carlsbad, CA (US); Tao Gu, San Diego, CA (US); Jie Cai, Simi Valley, CA (US); Wan-Yun Hsieh, San Diego, CA (US); Alla Sutin, Encinitas, CA (US); Yufen Hu, San Diego, CA (US); Peng Wang, San Diego, CA (US); Michiharu Yamamoto, Carlsbad, CA (US)

(72) Inventors: Weiping Lin, Carlsbad, CA (US); Tao Gu, San Diego, CA (US); Jie Cai, Simi Valley, CA (US); Wan-Yun Hsieh, San Diego, CA (US); Alla Sutin, Encinitas, CA (US); Yufen Hu, San Diego, CA (US); Peng Wang, San Diego, CA (US); Michiharu Yamamoto, Carlsbad, CA (US)

(73) Assignee: NITTO DENKO CORPORATION, OSAKA (JP)

(21) Appl. No.: 14/001,106

(22) PCT Filed: Feb. 22, 2012
(86) PCT No.: PCT/US2012/026130

§ 371 Date: Aug. 22, 2013

Related U.S. Application Data
(60) Provisional application No. 61/445,917, filed on Feb. 23, 2011.

(51) Int. Cl. G02B 1/04

(52) U.S. Cl. CPC G02B 1/04
USPC 252/582

(57) ABSTRACT

A photorefractive composition and a photorefractive device comprising the composition are disclosed. The composition is configured to be photorefractive upon irradiation by a laser having a wavelength in the visible light spectrum and comprises a polymer, a non linear optical chromophore, a plasticizer, and an electrolyte. In an embodiment, the percentage of polymer recurring units that comprise a charge transport moiety is less than 30%. In an embodiment, the electrolyte comprises one or more of ammonium salts, heterocyclic ammonium salts, and phosphonium salts. In an embodiment, the polymer is selected from the group consisting of polycarbonate, polyurea, polyurethane, poly(meth)acrylate, polyester, polyimide, and combinations thereof. Preferably, the composition has a diffraction efficiency of about 25% or greater upon irradiation with a visible light laser.

### CROSS-REFERENCE TO RELATED APPLICATIONS

The present application claims priority under 35 U.S.C. §119(e) to U.S. Provisional Application No. 61/445,917 filed on Feb. 23, 2011, the disclosures of which is incorporated by reference herein in its entirety.

### STATEMENT REGARDING FEDERALLY SPONSORED R&D

This invention was made with government support under FA8650-10-C-7034 awarded by the Office of the Director of National Intelligence (ODNI), Intelligence Advance Research Projects Activity (IARPA), through the Air Force Research Laboratory (AFRL). The government has certain rights in the invention.

### BACKGROUND OF THE INVENTION

1. Field of the Invention

The invention relates to a photorefractive composition and a photorefractive device comprising the composition, wherein the composition is configured to be photorefractive upon irradiation by a laser having a wavelength in the visible light spectrum, wherein the composition comprises a polymer, a chromophore, a plasticizer, and one or more electrolytes.

2. Description of the Related Art

Photorefractivity is a phenomenon in which the refractive index of a material can be altered by changing the electric field within the material, such as by laser beam irradiation. The change of the refractive index is achieved by a series of steps, including: (1) charge generation by laser irradiation, (2) charge transport, resulting in the separation of positive and negative charges, (3) trapping of one type of charge (charge delocalization), (4) formation of a non-uniform internal electric field (space-charge field) as a result of charge delocalization, and (5) refractive index change induced by the non-uniform electric field. Therefore, good photorefractive properties can generally be seen in materials that combine good charge generation, good charge transport or photoconductivity, and good electro-optical activity.

Photorefractive materials have many promising applications, such as high-density optical data storage, dynamic holography, optical image processing, phase conjugated minors, optical computing, parallel optical logic, and pattern recognition. Originally, the photorefractive effect was found in a variety of inorganic electro-optical (EO) crystals, such as LiNbO₃. In these materials, the mechanism of the refractive index modulation by the internal space-charge field is based on a linear electro-optical effect. Usually inorganic electro-optical (EO) crystals do not require biased voltage for the photorefractive behavior.

In 1990 and 1991, the first organic photorefractive crystal and polymeric photorefractive materials were discovered and reported. Such materials are disclosed, for example, in U.S. Pat. No. 5,064,264, to Ducharme et al, the contents of which are hereby incorporated by reference. Organic photorefractive materials offer many advantages over the original inorganic photorefractive crystals, such as large optical non-linearities, low dielectric constants, low cost, light weight, structural flexibility, and ease of device fabrication. Other important characteristics that may be desirable, depending on the application, include long shelf life, optical quality, and thermal stability. These kinds of active organic polymers are emerging as key materials for advanced information and telecommunication technology.

In recent years, efforts have been made to optimize the properties of organic, and particularly polymeric, photorefractive materials. As mentioned above, good photorefractive properties depend upon good charge generation, good charge transport, also known as photoconductivity, and good electro-optical activity. Various studies have been performed to examine the selection and combination of the components that give rise to each of these features. The photoconductive capability is frequently provided by incorporating materials containing carbazole groups. Phenyl amine groups can also be used for the charge transport part of the material.

Particularly, several new organic photorefractive compositions which have better photorefractive performances, such as high diffraction efficiency, fast response time, and long phase stabilities, have been developed, for example, in U.S. Pat. Nos. 6,809,156, 6,653,421, 6,646,107, 6,610,809 and U.S. Patent Application Publication No. 2004/0077794 (Nitto Denko Technical), all of which are hereby incorporated by reference. These patents and patent applications disclose methodologies and materials to make triphenyl diamine (TPD) type photorefractive compositions which show very fast response times and good gain coefficients. Efforts have also been made to improve grating holding persistency, for examples, in WO 2008/091716 A1 and EP 2126625 A1, which are hereby incorporated by reference. These references disclose methodologies to utilize approximately half the biased voltage normally used, advantageously resulting in a longer device lifetime by incorporating a polymer layer into the device.

However, the TPD acrylate monomer is not readily commercially available and may be difficult to obtain. Additionally, the synthesis of TPD acrylate monomer is complicated, requiring multiple, e.g. nine to ten, steps. As such, the difficulties of synthesizing TPD based polymers render their price quite high. The complicated synthesis represents a hurdle for manufacturing or large scale production of photorefractive devices. Therefore, there is a need to develop alternative, more economically less expensive photorefractive materials.

### SUMMARY OF THE INVENTION

An embodiment provides a photorefractive composition that comprises a polymer, a chromophore, a plasticizer, and an electrolyte. In an embodiment, the percentage of polymer recurring units that comprise a charge transport moiety is less than 30%. In an embodiment, the percentage of polymer recurring units that comprise a charge transport moiety is less than 20%. In an embodiment, the percentage of polymer recurring units that comprise a charge transport moiety is less than 10%. In an embodiment, the polymer is free of charge transport moieties. In an embodiment, the composition is configured to be photorefractive upon irradiation by a laser having a wavelength in the visible light spectrum.

Polymers that are free or substantially free of charge transport moieties provide improved benefits because they are easier to manufacture and are available at reduced costs. It was previously believed that charge transport moieties were necessary in organic, polymeric photorefractive compositions because photorefractivity is dependent upon the ability to generate charge transport. Surprisingly, it has been discovered by the present inventors that sufficient photorefractive behavior can be generated even when the charge transport moieties have been reduced or eliminated.

The polymer can be free or substantially free of any moiety known as useful for charge transport by one having ordinary skill in the art. In an embodiment, the charge transport moieties are represented by the following formulae (Ia), (Ib), (Ic):

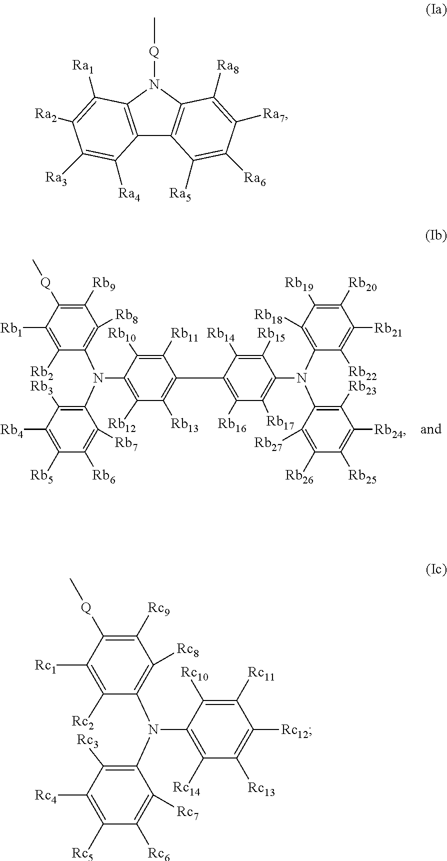

wherein each Q in formulae (Ia), (Ib) and (Ic) independently represents an alkylene group having from 1 to 10 carbon atoms or a heteroalkylene group having from 1 to 10 carbon atoms, Ra₁-Ra₈, Rb₁-Rb₂₇ and Rc₁-Rc₁₄ in formulae (Ia), (Ib), and (Ic) are each independently selected from the group consisting of hydrogen, C₁-C₁₀ alkyl, and C₄-C₁₀ aryl, wherein the C₁-C₁₀ alkyl may be linear or branched.

Various polymers can be used in the photorefractive composition. In an embodiment, the polymer is selected from the group consisting of polycarbonate, polyurea, polyurethane, polyacrylate, polymethacrylate, polyester, polyimide, and combinations thereof. For example, the polymer can be selected from the group consisting of amorphous polycarbonate, polymethylmethacrylate, and polyimide. The composition may comprise the polymer in various amounts. In an embodiment, the composition comprises the polymer in an amount in the range of about 10% to about 50% by weight of the composition. In an embodiment, the composition comprises the polymer in an amount in the range of about 20% to about 50% by weight of the composition.

Despite the lack of charge transport moieties on the polymers in the composition, the photorefractive compositions still exhibit sufficient diffraction efficiency to be operable in photorefractive devices. In an embodiment, the composition has a diffraction efficiency of 10% or greater upon irradiation with a laser having a wavelength in the visible light spectrum. In an embodiment, the composition has a diffraction efficiency of 20% or greater upon irradiation with a laser having a wavelength in the visible light spectrum. In an embodiment, the composition has a diffraction efficiency of 30% or greater upon irradiation with a laser having a wavelength in the visible light spectrum. In an embodiment, the visible light laser is a green laser. In an embodiment, the visible light laser has a wavelength of about 532 nm.

The photorefractive composition also comprises a chromophore. Preferably, the chromophore is a non-linear optical chromophore. In an embodiment, the composition comprises the chromophore in an amount in the range of about 10% to about 50% by weight of the composition. In an embodiment, the composition comprises the chromophore in an amount in the range of about 20% to about 40% by weight of the composition.

The photorefractive composition also comprises one or more electrolytes. Various electrolytes can be used. The incorporation of electrolytes into the photorefractive composition surprisingly has the advantage of reducing the grating response time and/or the grating decay time. The electrolytes can be dispersed among the photorefractive layer and improves grating response and grating decay times. For example, the grating response time can be as fast as 100 seconds, more preferably as fast as 10 seconds, more preferably as fast as 5 seconds, more preferably as fast as 1 second, and more preferably as fast as 0.2 seconds. Without one or more electrolytes in the photorefractive layer, the grating response time was measured to be about 8000 seconds. The grating decay time can be as fast as 50 seconds, more preferably as fast as 10 seconds, more preferably as fast as 5 seconds, and more preferable as fast as 2 seconds.

In an embodiment, the photorefractive composition further comprises a sensitizer. The amount of sensitizer can vary. In an embodiment, the composition comprises sensitizer in an amount in the range up to about 10% by weight of the composition. In an embodiment, the composition comprises sensitizer in an amount in the range up to about 5% by weight of the composition. In an embodiment, the composition comprises sensitizer in an amount in the range up to about 1% by weight of the composition. In an embodiment, the composition has a transmittance of higher than about 30% at a thickness of 100 μm when irradiated by a laser having a wavelength in the visible light spectrum.

Further embodiments provide photorefractive devices that comprise any of the photorefractive compositions described herein.

These and other embodiments are described in greater detail below.

### DETAILED DESCRIPTION OF THE PREFERRED EMBODIMENT

The present disclosure relates to a composition, a photorefractive device that comprises the composition, and a method of making the photorefractive device, wherein the composition is configured to be photorefractive upon irradiation by a laser having a wavelength in the visible light spectrum. In an embodiment, the composition comprises a polymer, a chromophore, a plasticizer, and an electrolyte. Preferably, the polymer is selected from the group consisting polycarbonate, polyurea, polyurethane, polymethacrylate, polyacrylate, polyester, polyimide and combinations thereof.

In an embodiment, the percentage of polymer recurring units that comprise a charge transport moiety is less than 30%. A “charge transport moiety” is a moiety attached to the polymer has the ability to transport a charge generated by laser irradiation, resulting in the separation of positive and negative charges. Some examples of charge transport moieties are described above as formulae (Ia), (Ib), and (Ic). In an embodiment, the polymer is free of charge transport moieties. In an embodiment, the polymer is substantially free of charge transport moieties. For example, the percentage of polymer recurring units that comprise a charge transport moiety, such as those represented in formulae (Ia), (Ib), and (Ic), can be less than 30%. In an embodiment, the percentage of polymer recurring units that comprise a charge transport moiety, such as those represented in formulae (Ia), (Ib), and (Ic), is less than 20%. In an embodiment, the percentage of polymer recurring units that comprise a charge transport moiety, such as those represented in formulae (Ia), (Ib), and (Ic), is less than 10%. In an embodiment, the percentage of polymer recurring units that comprise a charge transport moiety, such as those represented in formulae (Ia), (Ib), and (Ic), is less than 5%. In an embodiment, the composition is configured to be photorefractive upon irradiation by a laser having a wavelength in the visible light spectrum.

In an embodiment, the composition has a diffraction efficiency of about 25% or greater upon irradiation with a laser in the visible light spectrum. For example, a green laser can be used. In an embodiment, the composition has a diffraction efficiency of about 30% or greater upon irradiation with a laser in the visible light spectrum. In an embodiment, the composition has a diffraction efficiency of about 40% or greater upon irradiation with a laser in the visible light spectrum. In an embodiment, the composition has a diffraction efficiency of about 50% or greater upon irradiation with a laser in the visible light spectrum. In an embodiment, the composition has a diffraction efficiency of about 60% or greater upon irradiation with a laser in the visible light spectrum. In embodiment, the visible light wavelength laser is a green laser, preferably having a wavelength of about 532 nm.

Advantageously, as discussed in greater detail below, the photorefractive compositions described herein provide photorefractive devices at dramatically lower costs, while the device shows comparable diffraction efficiency as TPD based compositions. Photorefractive devices based upon this design may be used for a variety of purposes including, but not limited to, holographic image recording materials and devices.

Various types of polymers (including copolymers) can be used, so long as they are free or substantially free of moieties that have charge transport ability. Polycarbonate can be used. In an embodiment, a polycarbonate repeating unit can be represented by one of the following:

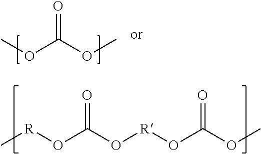

wherein R and R′ are independently selected from the group consisting of a linear alkylene group with up to 30 carbons, a branched alkylene group with up to 30 carbons, and an aromatic ring(s) with up to 30 carbons. In an embodiment, a polycarbonate repeating unit can be represented by the following repeating unit:

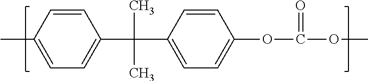

Polyurea can also be used for the polymer. In an embodiment, a polyurea repeating unit can be represented by one of the following:

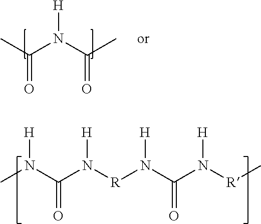

wherein R and R′ are independently elected from the group consisting of a linear alkylene group with up to 30 carbons, a branched alkylene group with up to 30 carbons, and an aromatic ring(s) with up to 30 carbons.

Polyurethane can also be used for the polymer. In an embodiment, a polyurethane repeating unit can be represented by one of the following:

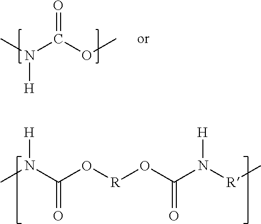

wherein R and R′ are independently selected from the group consisting of a linear alkylene group with up to 30 carbons, a branched alkylene group with up to 30 carbons, and an aromatic ring(s) with up to 30 carbons.

Poly(meth)acrylate can also be used for the polymer. The term “poly(meth)acrylate” refers to polymers containing acrylate and/or methacrylate recurring units, such as polyacrylate, polymethacrylate, and copolymers thereof. In an embodiment, a poly(meth)acrylate repeating unit can be represented by the following:

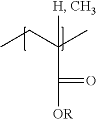

wherein R is selected from the group consisting of a linear alkyl group with up to 10 carbons, a branched alkyl group with up to 10 carbons, and an aromatic ring(s) with up to 20 carbons. In an embodiment, the polymethacrylate is represented by the following repeating unit:

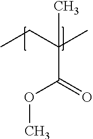

Polyester can also be used for the polymer. In an embodiment, a polyester repeating unit can be represented by one of the following:

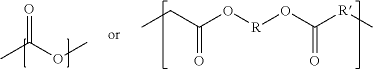

wherein R and R′ are independently selected from the group consisting of a linear alkylene group with up to 30 carbons, a branched alkylene group with up to 30 carbons, and an aromatic ring(s) with up to 30 carbons.

Polyimide can also be used for the polymer. In an embodiment, a polyimide repeating unit can be represented by the following:

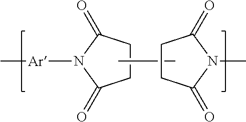

wherein Ar′ is an aromatic ring(s) with up to 30 carbons. In an embodiment, a polyimide repeating unit can be represented by the following:

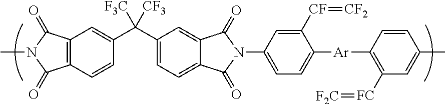

wherein Ar is an aromatic ring(s) with up to 30 carbons.

In an embodiment, each polymer main chain structure can be optionally modified with linear or branched substituted C₁-C₁₀ alkyl or heteroalkyl, and optionally substituted C₆-C₁₀ aryl. Preferably, the polymer comprises amorphous polycarbonate (APC), poly methylmethacrylate (PMMA) or polyimide.

Polymers such as APC, PMMA, and polyimide have very good thermal and mechanical properties. Such polymers provide better workability during processing by injection-molding or extrusion, for example. Physical properties of the matrix polymer that are of importance include, but are not limited to, the molecular weight and the glass transition temperature, Tg. Also, it is valuable and desirable, although optional, that the composition should be capable of being formed into films, coatings and shaped bodies of various kinds by standard polymer processing techniques, such as solvent coating, injection molding, and extrusion.

In the present invention, the polymer generally has a weight average molecular weight, Mw, in the range of from about 3,000 to 500,000, preferably from about 5,000 to 100,000. The term “weight average molecular weight” as used herein means the value determined by the GPC (gel permeation chromatography) method (using polystyrene standards), as is well known in the art.

In an embodiment, the photorefractive composition comprises the polymer in an amount in the range of about 10% to about 50% by weight of the composition. In an embodiment, the photorefractive composition comprises the polymer in an amount in the range of about 15% to about 45% by weight of the composition. In an embodiment, the photorefractive composition comprises the polymer in an amount in the range of about 20% to about 40% by weight of the composition. In an embodiment, the photorefractive composition comprises the polymer in an amount in the range of about 25% to about 35% by weight of the composition.

In an embodiment, one or more electrolytes are included in the photorefractive composition, i.e. the photorefractive layer. Various electrolytes can be used. An electrolyte contains free ions that make it electrically conductive. In an embodiment, one or more electrolytes comprise a salt. In an embodiment, one or more electrolytes comprise an organic salt. In an embodiment, the salt comprises one or more salt selected from the group consisting of an ammonium salt, such as a heterocyclic ammonium salt, an acridinium salt, a bipyridinium salts, a choline salt, a dequalinium salt, an imidazolium salt, morpholinium salt, a phosphonium salt, a piperidinium salt, a piperazinium salt, a pyrazolium salt, a pyridinium salt, a pyrrolidinium salt, a sulfonium salt, a thiazolium salt, and combinations thereof. Preferably, the one or more electrolytes can be selected from the group of consisting of ammonium salts, heterocyclic ammonium salts, phosphonium salts, and combinations thereof.

In an embodiment, the photorefractive composition comprises the electrolyte in an amount in the range of about 0.001% to about 5% by weight of the composition. In an embodiment, the photorefractive composition comprises the electrolyte in an amount in the range of about 0.005% to about 1% by weight of the composition. In an embodiment, the photorefractive composition comprises the electrolyte in an amount in the range of about 0.01% to about 0.5% by weight of the composition.

Tetraalkylammonium salts are very suitable because of excellent solubility characteristics in most organic solvents. Non-limiting examples of the electrolytes include 10-Methyl-9-phenylacridinium perchlorate, tetrabutylammonium fluorosulfate, tetraethylammonium bromide, tetraethylammonium chloride, tetraethylammonium tetrafluoroborate, tetraethylammonium hexafluorophosphate, tetraethylammonium iodide, tetraethylammonium perchlorate, tetraethylammonium trifluoromethanesulfonate, tetraethylammonium p-toluenesulfonate, tetrabutylammonium acetate, tetrabutylammonium bromide, tetrabutylammonium benzoate, tetrabutylammonium bis-trifluoromethanesulfonimidate, tetrabutylammonium hexafluorophosphate, tetrabutylammonium perchlorate, tetrabutylammonium trifluoromethanesulfonate, tetrabutylammonium tetrafluoroborate, tetrabutylammonium tetraphenylborate, tetrabutylammonium iodide, tetrabutylammonium nitrate, tetrabutylammonium p-toluenesulfonate, tetrabutylphosphonium hexafluorophosphate, tetrabutylphosphonium tetrafluoroborate, tetraethylammonium benzoate, tetraethylammonium bistrifluoromethanesulfonimidate, tetramethylammonium bromide, tetramethylammonium chloride, tetramethylammonium nitrate, tetrapentylammonium perchlorate, and tetrapropylammonium bromide.

The photorefractive composition further includes chromophore(s). In an embodiment, the composition comprises the chromophore selected from non-linear optics chromophores. The chromophore or group that provides the non-linear optical functionality may be any group known in the art to provide such capability. The non-linear optical chromophore can be an additive component to the composition. Preferably, the non-linear optical chromophore is not a moiety that is bonded to the matrix polymer.

The chromophore that provides the non-linear optical functionality used in the present invention is selected from organic compounds which can be described in the general structure:

D-Q-E_{acpt}

wherein D represents an electron donor group (such as a nitrogen containing functional group), Q is a group selected from the group consisting of a linear alkylene group with up to 30 carbons, a branched alkylene group with up to 30 carbons, and an aromatic ring(s) with up to 30 carbons, and E_{acpt} represents electron acceptor group.

For example, U.S. Pat. No. 5,064,264, which is hereby incorporated by reference in its entirety, describes using chromophores in photorefractive materials. Chromophores are known in the art and are well described in the literature, such as D. S. Chemla & J. Zyss, “Nonlinear Optical Properties of Organic Molecules and Crystals” (Academic Press, 1987), which is hereby incorporated by reference in its entirety. Also, U.S. Pat. No. 6,090,332, which is hereby incorporated by reference in its entirety, describes fused ring bridge, ring locked chromophores for use in thermally stable photorefractive compositions.

Non-limiting examples of chromophores are represented by the following chemical structures:

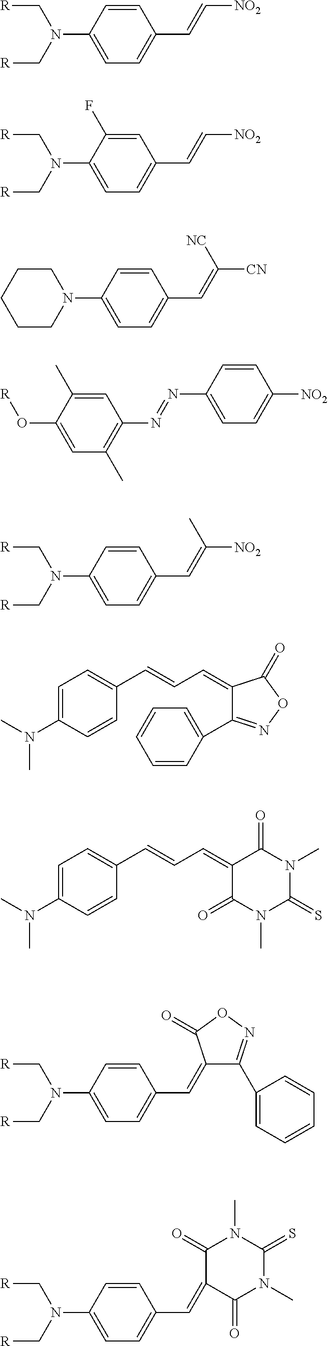

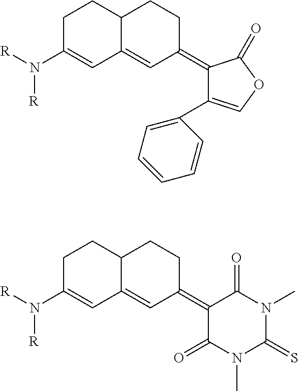

Each R in the above compounds can be organic substituents independently selected from alkenyls, alkyls, alkynyls, aryls, cycloalkenyls, cycloalkyls, and heteroaryls. In an embodiment, the heteroaryl has at least one heteroatom selected from O and S.

Other chromophores can be used. In some embodiments, the chromophore is represented by any one of the following structures:

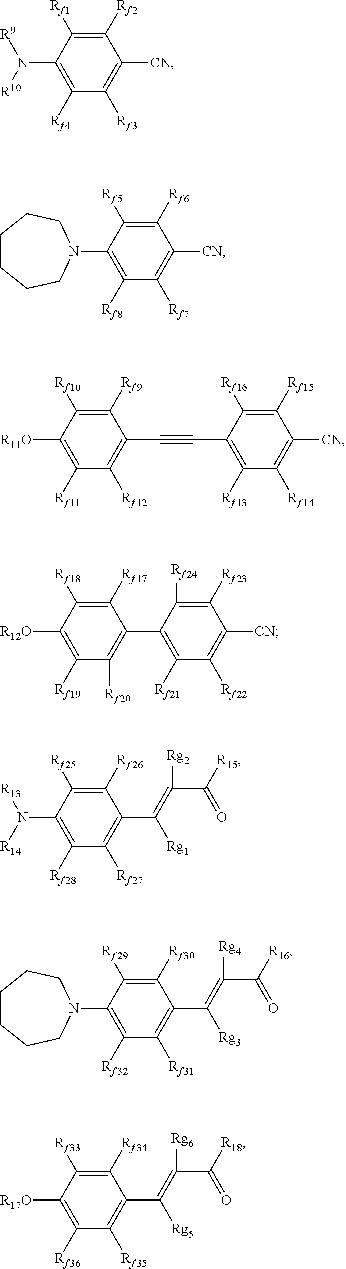

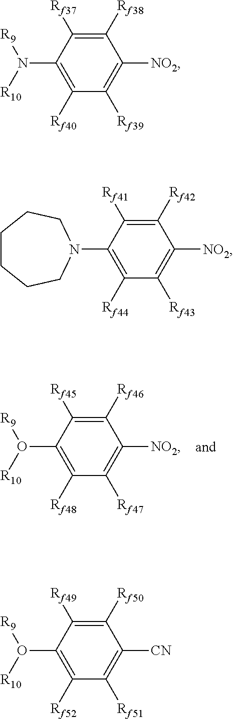

wherein each R₉-R₁₈ in the above chromophoric compounds is independently selected from the group consisting of hydrogen, C₁-C₁₀ alkyl, C₁-C₁₀ alkoxy, and C₄-C₁₀ aryl, wherein the alkyl and alkoxy groups may be branched or linear. In an embodiment, each Rf₁-Rf₅₂ in the above chromophoric compounds is independently selected from H, F, CH₃, CF₃, CN, NO₂, phenyl, CHO, and COCH₃. In an embodiment, each Rg₁-Rg₆ in the above chromophoric compounds is independently selected from H, F, CH₃, CF₃, CN, CH₂, phenyl, and COCH₃.

In an embodiment, the chromophore is selected from one or more of 1-(4-nitrophenyl)azepane, 4-(azepan-1-yl)benzonitrile, 4-(azepan-1-yl)-2-fluorobenzonitrile, 5-(azepan-1-yl)pyrimidine-2-carbonitrile, 5-(azepan-1-yl)-2-nitrophenol, 1-(4-nitro-3-(trifluoromethyl)phenyl)azepane, 1-(4-(perfluorohexylsulfonyl)phenyl)azepane, 1-(4-(S-perfluorohexyl-N-perfluoromethylsulfonyl-sulfinimidoyl)phenyl)azepane, 3-(4-butoxybenzylidene)pentane-2,4-dione, 3-(4-(azepan-1-yl)benzylidene)pentane-2,4-dione, 3-(4-phenoxybenzylidene)pentane-2,4-dione, methyl 3-(4-butoxyphenyl)-2-cyanoacrylate, methyl 3-(4-(azepan-1-yl)phenyl)acrylate, methyl 3-(4-butoxyphenyl)acrylate, ethyl 3-(4-(azepan-1-yl)phenyl)-2-methylacrylate, (Z)-ethyl 2-fluoro-3-(4-phenoxyphenyl)acrylate, ethyl 3-methyl-6-phenoxy-1H-indene-2-carboxylate, ethyl 3-(4-(azepan-1-yl)phenyl)-2-phenylacrylate, 4-((4-(2-butoxyethoxy)phenyl)ethynyl)-2,6-difluorobenzonitrile, 4-((4-(2-butoxyethoxy)phenyl)ethynyl)benzonitrile, 4-((4-(2-butoxyethoxy)phenyl)ethynyl)-2,6-difluorobenzonitrile, 4-((4-(2-ethylhexyloxy)phenyl)ethynyl)-2,6-difluorobenzonitrile, 4-((4-(2-butoxyethoxy)-2,6-difluorophenyl)ethynyl)-2,6-difluorobenzonitrile, 4′-(2-butoxyethoxy)-3,5-difluorobiphenyl-4-carbonitrile, 3,5-difluoro-4′-(2-(2-methoxyethoxy)ethoxy)biphenyl-4-carbonitrile, 2,6-difluoro-4-((4-(2-(2-methoxyethoxy)ethoxy)-2,6-dimethylphenyl)ethynyl)benzonitrile, 4-((2,6-difluoro-4-(2-(2-methoxyethoxy)ethoxy)phenyl)ethynyl)-2,6-difluorobenzonitrile. For example, the chromophore can be selected from the following compounds:

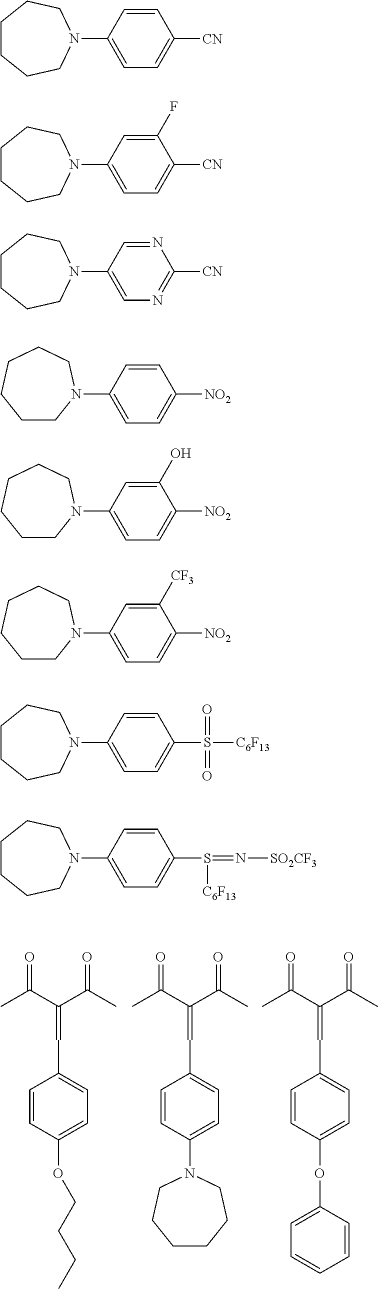

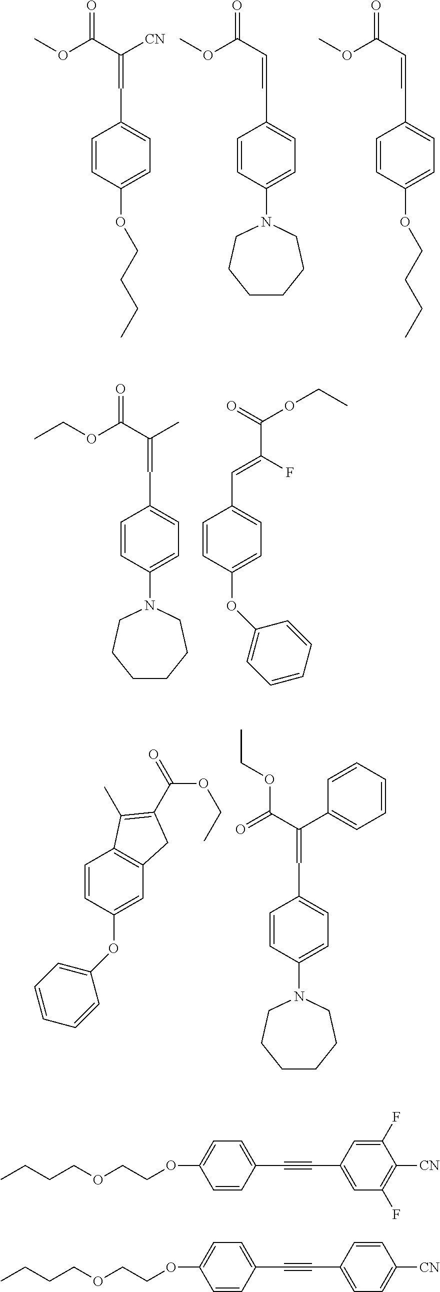

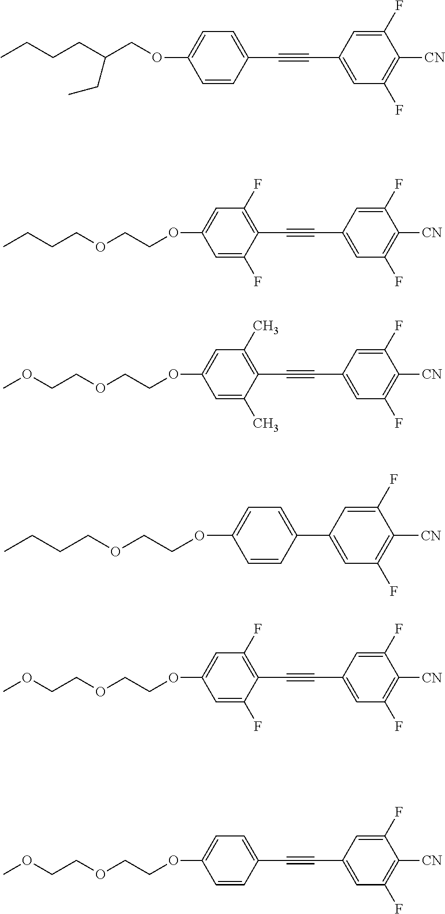

Preferably, the chromophore is a synthesized non-linear-optical chromophore 7-FDCST (7 member ring dicyanostyrene, 4-homopiperidino-2-fluorobenzylidene malononitrile). In another preferred embodiment, the chromophore is represented by Structure (IV):

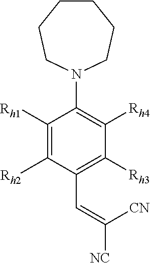

wherein Rₕ₁-Rₕ₄ are each independently selected from selected from H, F, CH₃, CF₃, CN, NO₂, phenyl, CHO, and COCH₃. In some embodiments, the chromophore is represented by Structure (IV) and at least one of Rₕ₂ and Rₕ₃ is F.

In an embodiment, the chromophore is selected from one or more of the following structures.

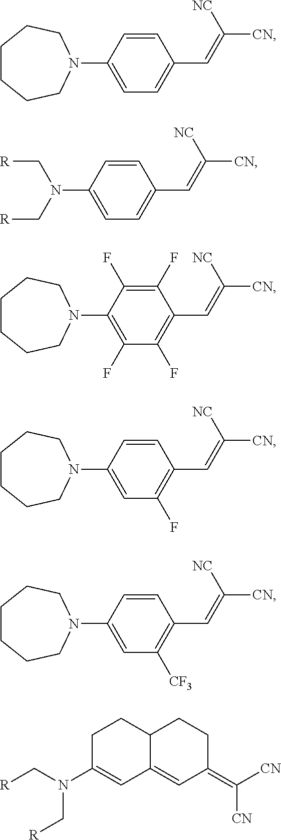

wherein R is a group selected from the group consisting of a hydrogen atom, a linear alkyl group with up to 10 carbons, a branched alkyl group with up to 10 carbons, and an aromatic group with up to 10 carbons.

Furthermore, as other mixable chromophores, a component that possesses non-linear optical properties through the polymer matrix, as is described in U.S. Pat. No. 5,064,264 to IBM, which is incorporated herein by reference, can be used. Suitable materials are known in the art and are well described in the literature, such as in D. S. Chemla & J. Zyss, “Nonlinear Optical Properties of Organic Molecules and Crystals” (Academic Press, 1987). Also, as described in U.S. Pat. No. 6,090,332 to Seth R. Marder et. al., fused ring bridge, ring locked chromophores that form thermally stable photorefractive compositions can be used. For typical, non-limiting examples of chromophore additives, the following chemical structure compounds can be used:

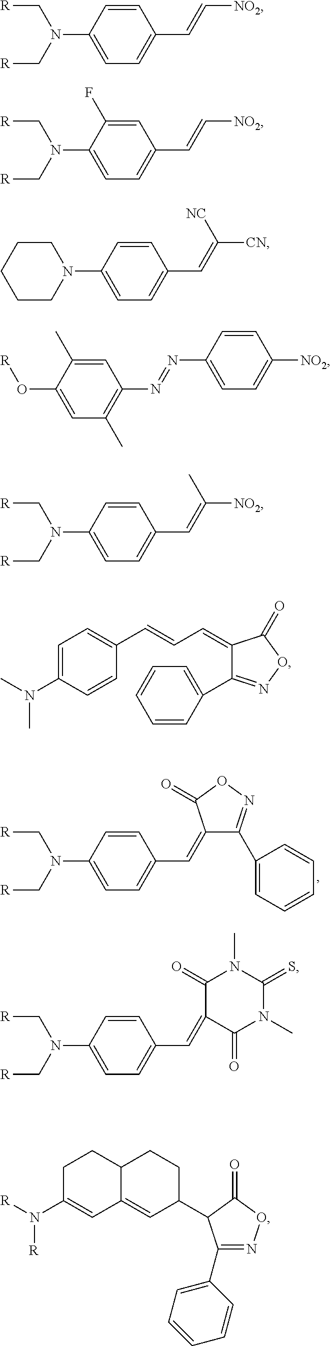

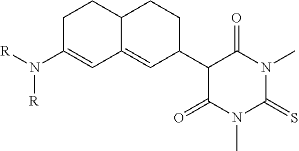

In some embodiments, the chromophore can also be attached to the polymer. For example, the chromophore can be represented by the Structure (0):

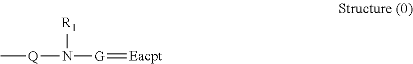

where Q represents an attachment to the polymer that comprises an alkylene or heteroalkylene group having at least one of heteroatom selected from S and O, and preferably Q is an alkylene group represented by (CH₂)ₚ (p=2˜6); R₁ represents hydrogen, linear or branched C₁-C₁₀ alkyl, and C₆-C₁₀ aryl, and preferably R₁ is an alkyl group selected from methyl, ethyl, propyl, butyl, pentyl and hexyl group; G represents π-conjugated group; and Eacpt represents electron acceptor group. Preferably Q is selected from the group consisting of ethylene, propylene, butylene, pentylene, hexylene, and heptylene.

In this context, the term “a π-conjugated group” refers to a molecular fragment that connects two or more chemical groups by π-conjugated bond. A π-conjugated bond contains covalent bonds between atoms that have σ bonds and π bonds formed between two atoms by overlap of their atomic orbits (s+p hybrid atomic orbits for σ bonds; p atomic orbits for π bonds).

The term “electron acceptor” refers to a group of atoms with a high electron affinity that can be bonded to a π-conjugated bridge. Exemplary acceptors, in order of increasing strength, are: C(O)NR²<C(O)NHR<C(O)NH₂<C(O)OR<C(O)OH<C(O)R<C(O)H<CN<S(O)₂R<NO₂, wherein R and R² are each independently selected from the group consisting of hydrogen, linear or branched C₁-C₁₀ alkyl, and C₆-C₁₀ aryl group.

Exemplary electron acceptor groups are described in U.S. Pat. No. 6,267,913, which is hereby incorporated by reference in its entirety. At least a portion of these electron acceptor groups are shown in the structures below. The symbol “‡” in the chemical structures below specifies an atom of attachment to another chemical group and indicates that the structure is missing a hydrogen that would normally be implied by the structure in the absence of the “‡”.

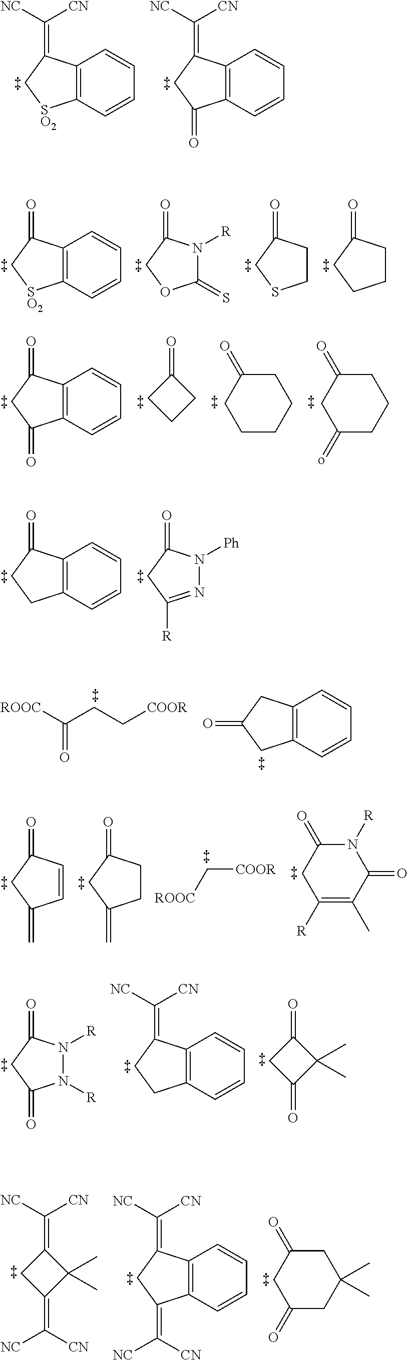

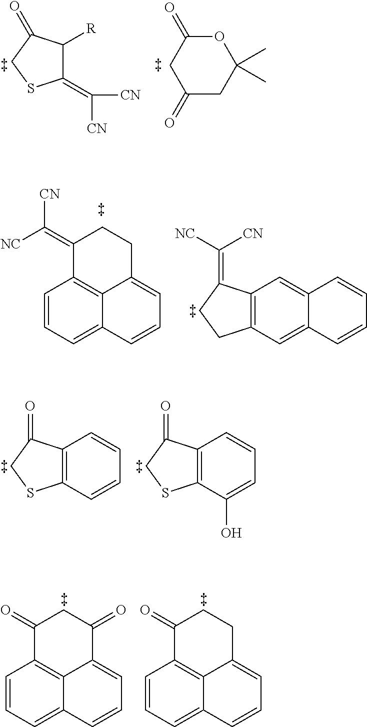

wherein R in the above moieties represents hydrogen, linear or branched C₁-C₁₀ alkyl, or C₆-C₁₀ aryl group.

Preferred chromophore groups are aniline-type groups or dehydronaphthyl amine groups.

In some embodiments, the chromophore is represented by Structure (0) and G is a π-conjugated group represented by Structure (I) or (II):

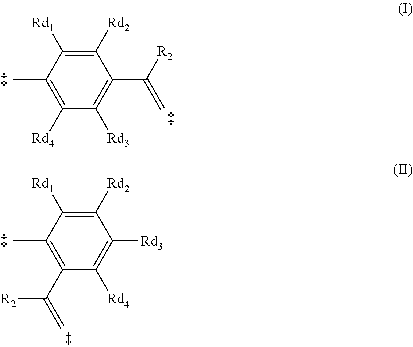

wherein Rd₁-Rd₄ in (I) and (II) are each independently selected from the group consisting of hydrogen, linear or branched C₁-C₁₀ alkyl, C₆-C₁₀ aryl, and preferably Rd₁-Rd₄ are all hydrogen; and R₂ in (I) and (II) is independently selected from hydrogen, linear or branched C₁-C₁₀ alkyl, and C₆-C₁₀ aryl group.

In some embodiments, Eacpt in Structure (0) is an electron-acceptor group represented by a structure selected from the group consisting of the following:

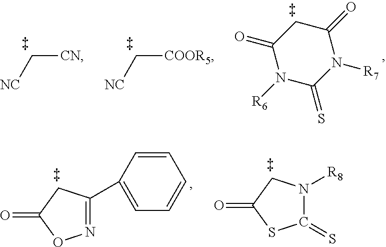

wherein R₅, R₆, R₇ and R₈ are each independently selected from the group consisting of hydrogen, linear or branched C₁-C₁₀ alkyl, and C₆-C₁₀ aryl group.

In an embodiment, the photorefractive composition comprises the chromophore in an amount in the range of about 10% to about 50% by weight of the composition. In an embodiment, the photorefractive composition comprises the chromophore in an amount in the range of about 15% to about 45% by weight of the composition. In an embodiment, the photorefractive composition comprises the chromophore in an amount in the range of about 20% to about 40% by weight of the composition. In an embodiment, the photorefractive composition comprises the chromophore in an amount in the range of about 25% to about 35% by weight of the composition.

The compositions can be mixed with a component that possesses plasticizer properties into the polymer matrix. As preferred plasticizer compounds, any commercial plasticizer compound can be used, such as phthalate derivatives or low molecular weight hole transfer compounds, for example N-alkyl carbazole or triphenylamine derivatives or acetyl carbazole or triphenylamine derivatives. Preferred embodiments of the invention provide polymers of comparatively low Tg. The inventors have recognized that this provides a benefit in terms of lower dependence on plasticizers. By selecting polymers of intrinsically moderate Tg, it is possible to limit the amount of plasticizer in the composition to preferably no more than about 30% or 25%, and more preferably lower, such as no more than about 20%.

Non-limiting examples of the plasticizer include ethyl carbazole; 4-(N,N-diphenylamino)-phenylpropyl acatate; 4-(N,N-diphenylamino)-phenylmethyloxy acatate; N-(acetoxypropylphenyl)-N,N′, N′-triphenyl-(1,1′-biphenyl)-4,4′-diamine; N-(acetoxypropylphenyl)-N′-phenyl-N,N′-di(4-methylphenyl)-(1,1′-biphenyl)-4,4′-diamine; and N-(acetoxypropylphenyl)-N′-phenyl-N,N′-di(4-buthoxyphenyl)-(1,1′-biphenyl)-4,4′-diamine. Such compounds can be used singly or in mixtures of two or more. Also, un-polymerized monomers can be low molecular weight hole transfer compounds, for example 4-(N,N-diphenylamino)-phenylpropyl(meth)acrylate; N-[(meth)acroyloxypropylphenyl]-N,N′,N′-triphenyl-(1,1′-biphenyl)-4,4′-diamine; N-[(meth)acroyloxypropylphenyl]-N′-phenyl-N,N′-di(4-methylphenyl)-(1,1′-biphenyl)-4,4′-diamine; N-[(meth)acroyloxypropylphenyl]-N′-phenyl-N,N′-di(4-buthoxyphenyl)-(1,1′-biphenyl)-4,4′-diamine, Dibuthyl Phtalate, and Benxyl Buthyl Phthalate. Such derivatives can be used singly or in mixtures of two or more.

In an embodiment, the photorefractive composition comprises the plasticizer in an amount in the range of about 10% to about 50% by weight of the composition. In an embodiment, the photorefractive composition comprises the plasticizer in an amount in the range of about 15% to about 45% by weight of the composition. In an embodiment, the photorefractive composition comprises the plasticizer in an amount in the range of about 20% to about 40% by weight of the composition. In an embodiment, the photorefractive composition comprises the plasticizer in an amount in the range of about 25% to about 35% by weight of the composition.

Optionally, other components may be added to the polymer matrix to provide or improve the desired physical properties mentioned earlier. Usually, for good photorefractive capability, it is preferred to add a photosensitizer to serve as a charge generator. A wide choice of such photosensitizers is known in the art. One suitable sensitizer includes a fullerene. “Fullerenes” are carbon molecules in the form of a hollow sphere, ellipsoid, tube, or plane, and derivatives thereof. One example of a spherical fullerene is C₆₀. While fullerenes are typically comprised entirely of carbon molecules, fullerenes may also be fullerene derivatives that contain other atoms, e.g., one or more substituents attached to the fullerene. In an embodiment, the sensitizer is a fullerene selected from C₆₀, C₇₀, C₈₄, each of which may optionally be substituted. In an embodiment, the fullerene is selected from soluble C₆₀ derivative [6,6]-phenyl-C61-butyricacid-methylester, soluble C₇₀ derivative [6,6]-phenyl-C₇₁-butyricacid-methylester, or soluble C₈₄ derivative [6,6]-phenyl-C₈₅-butyricacid-methylester. Fullerenes can also be in the form of carbon nanotubes, either single-wall or multi-wall. The single-wall or multi-wall carbon nanotubes can be optionally substituted with one or more substituents. Another suitable sensitizer includes a nitro-substituted fluorenone. Non-limiting examples of nitro-substituted fluorenones include nitrofluorenone, 2,4-dinitrofluorenone, 2,4,7-trinitrofluorenone, and (2,4,7-trinitro-9-fluorenylidene)malonitrile. Fullerene and fluorenone are non-limiting examples of photosensitizers that may be used. The amount of photosensitizer required is usually less than about 3 wt %.

In an embodiment, the photorefractive composition comprises the sensitizer in an amount in the range of about 0.001% to about 5% by weight of the composition. In an embodiment, the photorefractive composition comprises the sensitizer in an amount in the range of about 0.001% to about 2% by weight of the composition. In an embodiment, the photorefractive composition comprises the sensitizer in an amount in the range of about 0.05% to about 1% by weight of the composition. In an embodiment, the photorefractive composition comprises the sensitizer in an amount in the range of about 0.1% to about 0.5% by weight of the composition.

In an embodiment of the present invention, the composition has a transmittance of higher than about 30% at a thickness of 100 μm when irradiated by a laser, for example, a laser having a visible light wavelength of about 532 nm.

The photorefractive layer can have a variety of thickness values for use in a photorefractive device. In an embodiment, the photorefractive layer is about 10 to about 200 μm thick. In an embodiment, the photorefractive layer is about 25 to about 100 μm thick. Such ranges of thickness allow for the photorefractive material to give good grating behavior.

One embodiment of the present disclosure provides a method of making a photorefractive device. In an embodiment, the method comprises providing a photorefractive layer that comprises a polymer, a chromophore, a plasticizer, and adding one or more electrolytes to the photorefractive layer. In an embodiment, the polymer is selected from the group consisting of selected from the group consisting of polycarbonate, polyurea, polyurethane, polyacrylate, polymethacrylate, polyester, polyimide, and combinations thereof.

In one embodiment, the photorefractive device comprises an electrode. In an embodiment, the electrode is a transparent electrode. A transparent electrode may be further configured as a conducting film. The material comprising the conducting film may be independently selected from the group consisting of metal oxides, metals, and organic films with an optical density less than about 0.2. Non-limiting examples of transparent electrodes include indium tin oxide (ITO), tin oxide, zinc oxide, polythiophene, gold, aluminum, polyaniline, and combinations thereof. Preferably, one or more transparent electrodes are independently selected from the list consisting of indium tin oxide and zinc oxide.

In an embodiment, the photorefractive device comprises a substrate. Non-limiting examples of the substrate layers include soda lime glass, silica glass, borosilicate glass, gallium nitride, gallium arsenide, sapphire, quartz glass, polyethylene terephthalate, and polycarbonate. Preferably the substrate comprises a material with a refractive index of 1.5 or less.

Preferred embodiments of the invention provide polymers of comparatively low Tg. The inventors have recognized that this provides a benefit in terms of lower dependence on plasticizers. By selecting polymers of intrinsically moderate Tg, it is possible to limit the amount of plasticizer required for the composition to preferably no more than about 30% or 25%, and more preferably lower, such as no more than about 20%.

### EXAMPLES

It has been discovered that photorefractive devices produced using the compositions and methods disclosed above can achieve good grating efficiency. These benefits are further described by the following examples, which are intended to be illustrative of the embodiments of the disclosure, but are not intended to limit the scope or underlying principles in any way.

### (a) Monomers Containing Charge Transport Groups—TPD Acrylate Monomer:

Triphenyl diamine type (N-[acroyloxypropylphenyl]-N,N′,N′-triphenyl-(1,1′-biphenyl)-4,4′-diamine) (TPD acrylate) were purchased from Wako Chemical, Japan. The TPD acrylate type monomers have the structure:

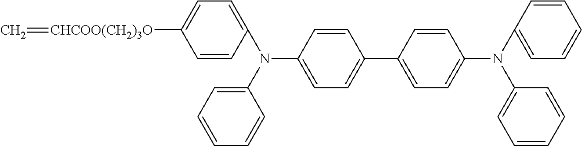

### (b) Polymer Matrix APC and PMMA:

APC and PMMA are commercially available from Aldrich and were used as received without further processing.

### (c) Synthesis of Non-Linear-Optical Chromophore 7-FDCST

The non-linear-optical precursor 7-FDCST (7 member ring dicyanostyrene, 4-homopiperidino-2-fluorobenzylidene malononitrile) was synthesized according to the following two-step synthesis scheme:

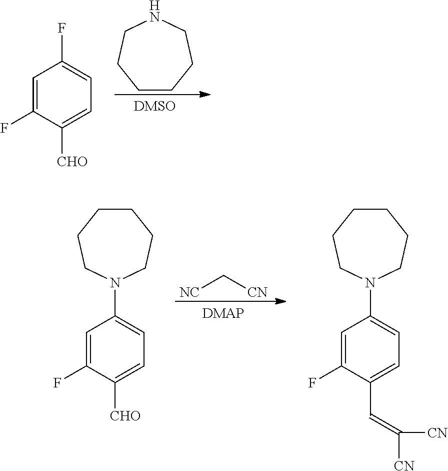

A mixture of 2,4-difluorobenzaldehyde (25 g, 176 mmol), homopiperidine (17.4 g, 176 mmol), lithium carbonate (65 g, 880 mmol), and DMSO (625 mL) was stirred at 50° C. for 16 hours. Water (50 mL) was added to the reaction mixture. The products were extracted with ether (100 mL). After removal of ether, the crude products were purified by silica gel column chromatography using hexanes-ethyl acetate (9:1) as eluent and crude intermediate was obtained (22.6 g). 4-(Dimethylamino)pyridine (230 mg) was added to a solution of the 4-homopiperidino-2-fluorobenzaldehyde (22.6 g, 102 mmol) and malononitrile (10.1 g, 153 mmol) in methanol (323 mL). The reaction mixture was kept at room temperature and the product was collected by filtration and purified by recrystallization from ethanol. The compound yield was 18.1 g (38%).

### (d) Synthesis of Non-Linear Optical Chromophore 1-Hexamethyleneimine-4-Nitrobenzene

The non-linear-optical, chromophore 1-hexamethyleneimine-4-nitrobenzene was synthesized according to the following synthesis scheme:

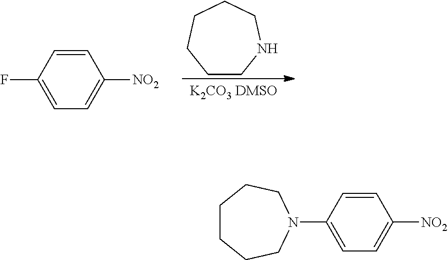 [SMILES: O=[N+]([O-])c1ccc(F)cc1 ; C1CCCNCC1 ; O=[N+]([O-])c1ccc(N2CCCCCC2)cc1]

A mixture of 4-fluorobenzaldehyde (3 g, 21.26 mmol), homopiperidine (2.11 g, 21.26 mmol), lithium carbonate (3.53 g, 25.512 mmol), and DMSO (40 mL) was stirred at 50° C. for 16 hrs. Water (50 mL) was added to the reaction mixture. The products were extracted with ether (100 mL). After removal of ether, the crude products were recrystallized and yellow crystal was obtained. The compound yield was 4.45 g (95%).

(e) Synthesis of Non-Linear Optical Chromophore methyl 3-(4-(azepan-1-yl)phenyl)acrylate

The non-linear-optical chromophore methyl 3-(4-(azepan-1-yl)phenyl)acrylate was synthesized according to the following synthesis scheme:

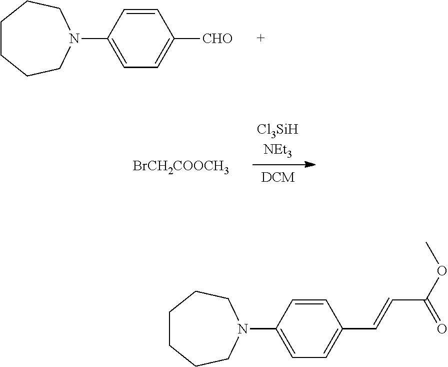 [SMILES: O=Cc1ccc(N2CCCCCC2)cc1 ; "+" ; "BrCH2COOCH3" ; COC(=O)/C=C/c1ccc(N2CCCCCC2)cc1]

In a 250 mL two-neck flask, anhydrous methylene chloride (60 mL) and 4-(azepan-1-yl)benzaldehyde (4.06 g, 20 mmol) were added. Then, methyl 2-bromoacetate (7.04 g, 46 mmol) followed by triethylamine (10.1 g, 100 mmol) and trichlorosilane (5.41 g, 40 mmol) were added at −10° C. under nitrogen atmosphere. The mixture was stirred at −10° C. for 8 hours and then gradually warmed to room temperature overnight. The reaction mixture was quenched by saturated NaHCO₃ aqueous solution and water. The products were extracted with ether and washed by brine and dried over MgSO₄. The crude products were purified by column. The compound yield was 2.48 g (48%).

### (f) Sensitizer

Sensitizer C₆₀ derivative [6,6]-phenyl-C₆₁-butyric acid methyl ester (PCBM, 99%, American Dye Source Inc.) is commercial available and were used as received from purchase without further processing.

### (g) Plasticizer

N-ethylcarbazole is commercially available from Aldrich and was used after recrystallization.

### (h) Matrix Polymer

Production Example 1

### Preparation of TPD Acrylate/Chromophore Type 10:1 Copolymer by AIBN Radical Initiated Polymerization

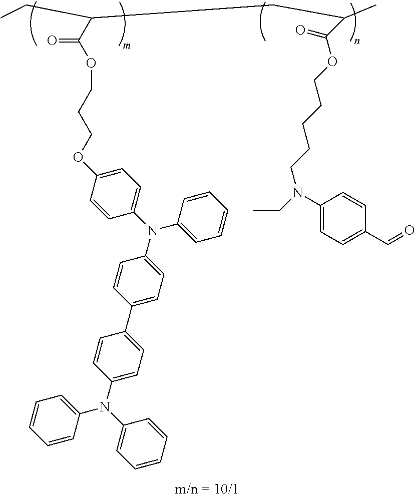

The charge transport monomer N-[(meth)acroyloxypropylphenyl]-N,N′,N′-triphenyl-(1,1′-biphenyl)-4,4′-diamine (TPD acrylate) (43.34 g), and the non-linear optical precursor monomer 5-[N-ethyl-N-4-formylphenyl]amino-pentyl acrylate (4.35 g), prepared as described in Example 1, were put into a three-necked flask. After toluene (400 mL) was added and purged by argon gas for 1 hour, azoisobutylnitrile (118 mg) was added into the solution. Then, the solution was heated to 65° C., while continuing to purge with argon gas.

After 18 hours of polymerization, the polymer solution was diluted with toluene. The polymer was precipitated from the solution and added to methanol, and the resulting polymer precipitate was collected and washed in diethyl ether and methanol. The white polymer powder was collected and dried. The yield of polymer was 66%.

The weight average and number average molecular weights were measured by gel permeation chromatography, using polystyrene standard. The results were Mn=10,600, Mw=17,100, giving a polydispersity of 1.61.

### Example 1

### Preparation of Photorefractive Devices

A photorefractive composition testing sample was prepared comprising two ITO-coated glass electrodes, and a photorefractive layer. The components of the photorefractive composition were approximately as follows:

| | |
|---|---|
| (i) Matrix polymer APC: | ~33 wt % |
| (ii) Prepared chromophore of 7F-DCST | ~33 wt % |
| (iii) Ethyl carbazole plasticizer | ~33 wt % |
| (iv) Electrolyte 10-methyl-9-phenylacridinium | listed in Table 1 |
| perchlorate (MPP) | |

To prepare the composition, the components listed above were dissolved in dichloromethane with stiffing and then dripped onto glass plates at 60° C. using a filtered glass syringe. The composites were then heated to 60° C. for five minutes and then vacuumed for five more minutes. The composites were then heated to 150° C. for five minutes and then vacuumed for 30 seconds. The composites were then scrapped and cut into chunks.

Small portions of this chunk were taken off and sandwiched between indium tin oxide (ITO) coated glass plates separated by a 105 μm spacer to form the individual samples.

### Measurement Method 1: Diffraction Efficiency

The diffraction efficiency was measured as a function of the applied field, by four-wave mixing experiments at about 532 nm with two s-polarized writing beams and a p-polarized probe beam. The angle between the bisector of the two writing beams and the sample normal was about 60 degrees and the angle between the writing beams was adjusted to provide an approximately 2.5 μm grating spacing in the material (about 20 degrees). The writing beams had approximately equal optical powers of about 0.45 mW/cm², leading to a total optical power of about 1.5 mW on the polymer, after correction for reflection losses. The beams were collimated to a spot size of approximately 500 μm. The optical power of the probe was about 100 μW.

The measurement of diffraction efficiency peak bias was performed as follows: The electric field (V/μm) applied to the photorefractive sample was varied from about 0 V/μm all the way up to about 100 V/μm within a certain time period (typically about 400 s), and the sample was illuminated with the two writing beams and the probe beam during this time period. Then, the diffracted beam was recorded. According to the theory,

$$η \sim {sin}^{2} ( k \frac{{E}_{0} {E}_{0}^{G}}{\sqrt{1 + {( {E}_{0}^{G} / {E}_{q} )}^{2}}} )$$

wherein E₀^{G} is the component of E₀ along the direction of the grating wave-vector and E_{q} is the trap limited saturation space-charge field. The diffraction efficiency will show maximum peak value at certain applied bias. The peak diffraction efficiency bias thus is a very useful parameter to determine the device performance.

### Example 2-9

A photorefractive device was obtained in the same manner as in Example 1 except that the electrolyte doping percentage and photorefractive layer thickness were different. The amount of electrolyte and photorefractive layer thicknesses are provided in Table 1.

### Comparative Example 1

A photorefractive device was obtained in the same manner as in the Example 1 except that no electrolytes were doped into composition.

The performances of each device is summarized as follows in Table 1.

TABLE 1
bias peak, response time, decay time and diffraction
efficiency of photorefractive device.

| | | thickness | Bias | Dif- | Re- | |
|---|---|---|---|---|---|---|
| | Polymer | of | peak | fraction | sponse | Decay |
| Example | matrix | PR layers | (kV) | efficiency | time (s) | time(s) |
| Comp. | APC | 100 μm | 4.0 | 60% at | 8000 | N/A |
| Ex. 1 | | | | 4 kv | | |
| Example 1 | APC + | 100 μm | 4.4 | 32% | 1.5 | 2 |
| | 1% MPP | | | | | |
| Example 2 | APC + | 50 μm | 3.5 | 14% | 0.25 | N/A |
| | 1% MPP | | | | | |
| Example 3 | APC + | 100 μm | 4.5 | 70% | 0.2 | 1.5 |
| | 0.2% MPP | | | | | |
| Example 4 | APC + | 50 μm | 3.5 | 65% | 0.6 | 2 |
| | 0.2% MPP | | | | | |
| Example 5 | APC + | 25 μm | 2.5 | 7% | 3.5 | 20 |
| | 0.2% MPP | | | | | |
| Example 6 | APC + | 100 μm | 4.5 | 40% | 0.3 | 5 |
| | 0.05% | | | | | |
| | MPP | | | | | |
| Example 7 | APC + | 50 μm | 2.7 | 13% | 0.75 | 5 |
| | 0.05% | | | | | |
| | MPP | | | | | |
| Example 8 | APC + | 100 μm | 3.8 | 70% | 5 | 15 |
| | 0.01% | | | | | |
| | MPP | | | | | |
| Example 9 | APC + | 100 μm | 4.1 | 40% | 100 | 50 |
| | 0.001% | | | | | |
| | MPP | | | | | |

As illustrated in Table 1, each of Examples 1-9 exhibited a similar diffraction efficiency and bias peak as compared to Comparative Example 1. However, the response time and decay time in Examples 1-9 are significantly faster. In particular, several of the examples reached millisecond levels of response time, which is much faster than Comparative Example 1, which took 8000 seconds.

### Examples 10-11

A photorefractive device was obtained in the same manner as in Example 1 except that the polymer in the photorefractive layer is PMMA. The electrolyte doping percentage and photorefractive layer thicknesses are provided in Table 2.

### Comparative Example 2

A photorefractive device was obtained in the same manner as in the Examples 10-11, except that no electrolytes were doped into composition. The photorefractive layer thickness is provided in Table 2

The performances of each device is summarized as follows in Table 2.

TABLE 2
bias peak, response time, decay time and diffraction
efficiency of photorefractive device.

| | Polymer | thickness of | Bias | Diffraction | Response | Decay |
|---|---|---|---|---|---|---|
| Example | matrix | PR layers | peak | efficiency | time (s) | time(s) |
| Comp. | PMMA | 100 μm | 2.3 kV | 20% at 2.3 kv | 14 | 340 |
| Ex. 2 | | | | | | |
| Example | PMMA + | 50 μm | 3.5 kV | 35% at 3.2 kV | 0.95 | 0.27 |
| 10 | 1% MPP | | | | | |
| Example | PMMA + | 100 μm | 2.9 kV | 70% at 2.5 kV | 7 | 32 |
| 11 | 0.01% MPP | | | | | |

Although the foregoing description has shown, described, and pointed out the fundamental novel features of the present teachings, it will be understood that various omissions, substitutions, and changes in the form of the detail of the apparatus as illustrated, as well as the uses thereof, may be made by those skilled in the art, without departing from the scope of the present teachings. Consequently, the scope of the present teachings should not be limited to the foregoing discussion, but should be defined by the appended claims. All patents, patent publications and other documents referred to herein are hereby incorporated by reference in their entirety.

1. A photorefractive composition configured to be photorefractive upon irradiation by a laser having a wavelength in the visible light spectrum that comprises a polymer, a chromophore, a plasticizer, and an electrolyte;
wherein the percentage of polymer recurring units that comprise a charge transport moiety is less than 30%;
wherein the charge transport moieties are represented by the following formulae (Ia), (Ib), (Ic): 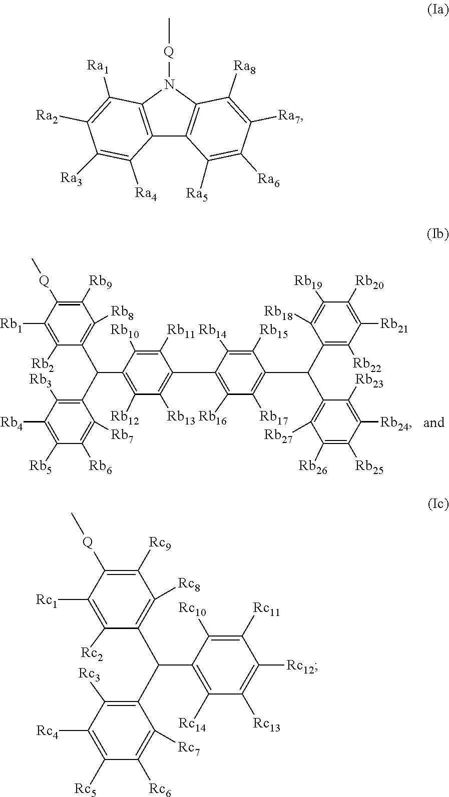
wherein each Q in formulae (Ia), (Ib) and (Ic) independently represents an alkylene group having from 1 to 10 carbon atoms or a heteroalkylene group having from 1 to 10 carbon atoms, Ra₁-Ra₈, Rb₁-Rb₂₇ and Rc₁-Rc₁₄ in formulae (Ia), (Ib), and (Ic) are each independently selected from the group consisting of hydrogen, C₁-C₁₀ alkyl, and C₄-C₁₀ aryl, wherein the C₁-C₁₀ alkyl may be linear or branched; and
wherein the composition is configured to be photorefractive upon irradiation by a laser having a wavelength in the visible light spectrum.

2. The photorefractive composition of claim 1, wherein the polymer is substantially free of charge transport moieties represented by the formulae (Ia), (Ib), and (Ic).

3. The photorefractive composition of claim 1, wherein the percentage of polymer recurring units that comprise a charge transport moiety is less than 20%.

4. The photorefractive composition of claim 3, wherein the polymer is substantially free of any charge transport moieties.

5. The photorefractive composition of claim 1, wherein the polymer is selected from the group consisting of polycarbonate, polyurea, polyurethane, polyacrylate, polymethacrylate, polyester, polyimide, and combinations thereof.

6. The photorefractive composition of claim 5, wherein the polymer is selected from the group consisting of amorphous polycarbonate, polymethylmethacrylate, and polyimide.

7. The photorefractive composition of claim 1, wherein the electrolyte is selected from the group of consisting of ammonium salts, heterocyclic ammonium salts, phosphonium salts, and combinations thereof.

8. The photorefractive composition of claim 1, wherein the amount of electrolytes in the photorefractive composition is in the range of about 0.001% to about 5% by weight of the composition.

9. The photorefractive composition of claim 1, wherein the grating response time and grating response time and grating decay time of the photorefractive composition is reduced compared to a photorefractive composition without electrolytes.

10. The photorefractive composition of claim 1, wherein the photorefractive composition has a diffraction efficiency of about 25% or greater upon irradiation with a visible light laser.

11. The photorefractive composition of claim 1, wherein the photorefractive composition comprises the polymer in an amount in the range of about 10% to about 50% by weight of the photorefractive composition.

12. The photorefractive composition of claim 1, wherein the photorefractive composition comprises the chromophore in an amount in the range of about 10% to about 50% by weight of the photorefractive composition.

13. The photorefractive composition of claim 1, further comprising a sensitizer.

14. A method of making a photorefractive device comprising:
providing a photorefractive layer that comprises a polymer, a chromophore, a plasticizer; and
adding one or more electrolytes to the photorefractive layer;
wherein the polymer is selected from the group consisting of selected from the group consisting of polycarbonate, polyurea, polyurethane, polyacrylate, polymethacrylate, polyester, polyimide, and combinations thereof.
